(19) United States
(12) Patent Application Publication
(10) Pub. No.: US 2016/0109020 A1
(43) Pub. Date: Apr. 21, 2016

(54) SYSTEM AND METHOD OF CONTROLLING TRANSMISSION

(71) Applicant: Hyundai Motor Company, Seoul (KR)

(72) Inventor: Jong Yun Park, Hwaseong (KR)

(21) Appl. No.: 14/704,428

(22) Filed: May 5, 2015

(30) Foreign Application Priority Data
Oct. 16, 2014 (KR) 10-2014-0139786

(51) Int. Cl. F16H 61/04

(52) U.S. Cl. CPC F16H 61/0403; F16H 2061/0418; F16H 2061/0422; F16H 2306/46; F16H 2306/48; F16H 2306/50

(57) ABSTRACT

A system and method of controlling a transmission having a synchro-mesh type shifting mechanism are provided. The method includes disengaging a sleeve of a synchronizer from a first clutch gear to engage the sleeve with the second clutch gear. A speed of the second clutch gear is synchronized with a speed of the sleeve. Engagement of the sleeve with the second clutch gear is the completed together with the synchronization. Therefore, the length of torque interruption is reduced and smoother shifting is achieved.

### CROSS REFERENCE TO RELATED APPLICATION

The present application claims priority of Korean Patent Application Number 10-2014-0139786 filed on Oct. 16, 2014, the entire contents of which application are incorporated herein for all purposes by this reference.

### BACKGROUND

1. Field of the Invention

The present invention generally relates to a system and method of controlling a transmission and, more particularly, to a system and method of controlling a synchro-mesh type transmission for a vehicle.

2. Description of the Related Art

In the related art, electric vehicles are equipped with a reducer. The reducer is configured to reduce power from a motor and transmit the power to driving wheels, but recently, power performance has been attempted to be improved to satisfy requests for a wider range of electric vehicle usage. Accordingly, the reducer of the related art has recently been replaced with a transmission capable of providing two or more transmission gear ratios to improve power performance in electric vehicles. For this purpose, a synchro-mesh type shifting mechanism, which has been generally used for the existing vehicles with a manual transmission, has been considered to achieve a simplified configuration and improved power transmission efficiency. However, such a synchro-mesh type shifting mechanism is accompanied by torque interruption, a phenomenon in which the power transmitted to driving wheels is cut in shifting from the current gear to the next gear, thereby generating shock.

The foregoing is intended merely to aid in the understanding of the background of the present invention, and is not intended to mean that the present invention falls within the purview of the related art that is already known to those skilled in the art.

### SUMMARY

Accordingly, the present invention provides a system and a method of controlling a transmission to provide smoother shifting by substantially reducing the length of torque interruption, when controlling a transmission using a synchro-mesh type shifting mechanism of the related art for shifting.

According to one aspect of the present invention, a method of controlling a transmission having a first speed gear and a second speed gear for implementing shifting for two different speeds at both sides from a synchronizer is provided. The method may include: moving a sleeve of the synchronizer to be disengaged from a first clutch gear directly connected to the first speed gear and to be engaged with a second clutch gear directly connected to the second speed gear; synchronizing a speed of the second clutch gear with a speed of the sleeve with a motor M connected with an input shaft while a synchronizer ring slides on a friction cone of the second clutch gear by the moving of a sleeve; and completing engagement of the sleeve with the second clutch gear, together with the synchronization of the speeds of the second clutch gear and the sleeve by the synchronizing.

According to another aspect of the present invention, a method of controlling a transmission may include: disengaging a sleeve of a synchronizer from a first clutch gear to engage the sleeve with the second clutch gear; synchronizing a speed of the second clutch gear with a speed of the sleeve; and completing engagement of the sleeve with the second clutch gear together with the synchronization in the second step.

Therefore, according to the present invention, it may be possible to provide smoother shifting by substantially reducing the length of torque interruption, when controlling a transmission using a synchro-mesh type shifting mechanism of the related art for shifting.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a flowchart illustrating an exemplary embodiment of a method of controlling a transmission according to an exemplary embodiment of the present invention;

FIG. 2 is an exemplary diagram illustrating the configuration of a transmission available for the present invention according to an exemplary embodiment of the present invention;

FIG. 3 is an exemplary diagram illustrating first speed-shifting by the transmission of FIG. 2 according to an exemplary embodiment of the present invention;

FIGS. 4 and 5 are exemplary diagrams sequentially illustrating a process of second speed-shifting from the state of FIG. 3 according to an exemplary embodiment of the present invention; and

FIG. 6 is an exemplary diagram illustrating a process of shifting from the state of FIG. 3 to the state of FIG. 5, which is not implemented in the present invention according to the related art.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the tem controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinbelow, exemplary embodiments of the present invention will be described in detail with reference to the accompanying drawings. The method described herein below may be executed by a controller having a processor and a memory. In other words the method of controlling the transmission may be executed by a controller which may be an electric controller.

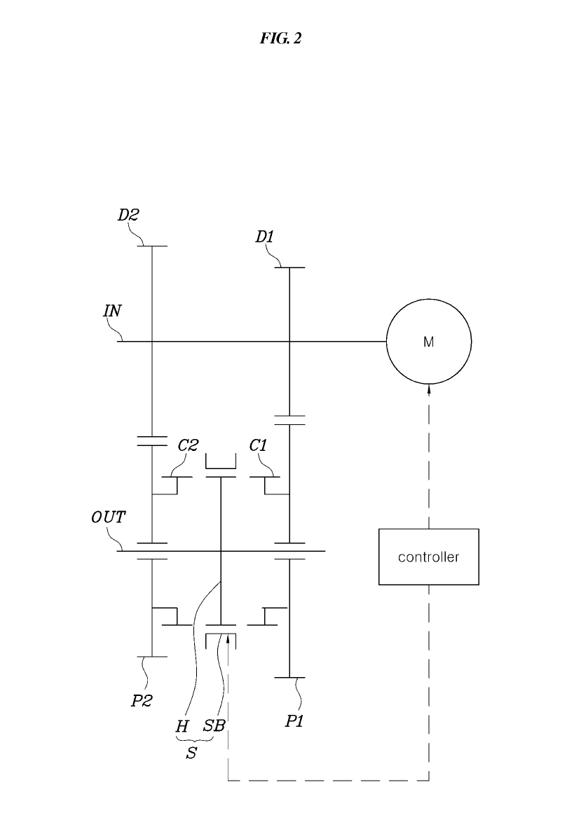

FIG. 2 illustrates the structure of a transmission available for the present invention, in which a motor M supplying power my be connected to an input shaft IN, a synchronizer S may be mounted on an output shaft OUT, a first driving gear D1 and a second driving gear D2 may be fitted on the input shaft IN, and a first speed gear P1 engaged with the first driving gear D2 and a second speed gear P2 engaged with the second driving gear D2 may be mounted on the output shaft OUT.

A first clutch gear C1 may be directly connected to the first speed gear P1, a second clutch gear C2 may be directly connected to the second speed gear P2, and the synchronizer S may be disposed to be shared between the first speed gear P1 and the second speed gear P2 and may include a hub H fitted on the output shaft OUT and a sleeve SB combined with the hub H by splines and axially moving to be engaged with the first clutch gear C1 or the second clutch gear C2. Further, though not shown in detail, the first clutch gear C1 and the second clutch gear C2 may each have a friction cone that protrudes toward the synchronizer S and thus, when the sleeve SB pushes a synchronizer ring toward the friction cone, the friction cone slides into the synchronizer ring for synchronization. For reference, the configuration and operation of the synchronizer S are the same as those of the synchro-mesh type shifting mechanism generally used in common transmissions.

In FIG. 2, the first driving gear D1 engaged with the first speed gear P1 and the second driving gear D2 engaged with the second speed gear P2 may be fitted on the input shaft IN connected to the motor M, and the first speed gear P1, the second speed gear P2, and the synchronizer S are on the output shaft OUT.

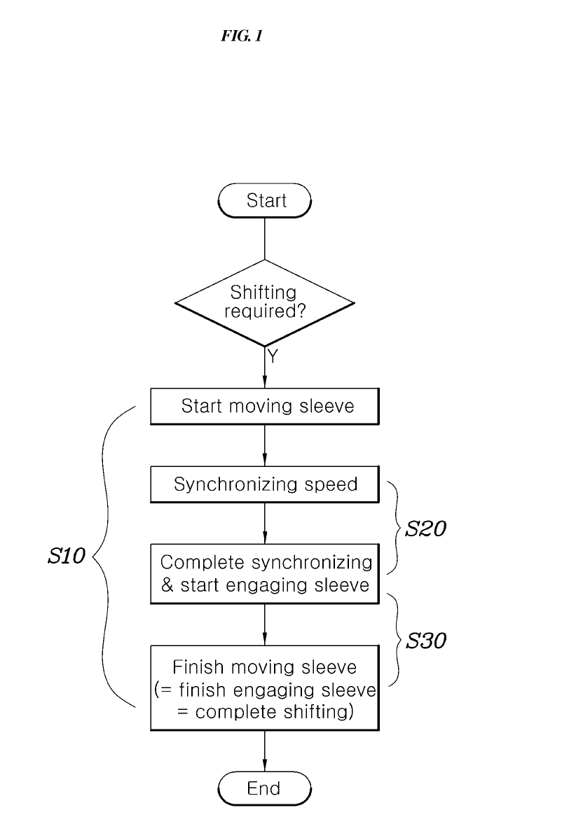

Retelling to FIG. 1, a method of controlling a transmission, which includes the first speed gear P1 and the second speed gear P2 for implementing shifting for two different speeds at both sides from the synchronizer, according to an exemplary embodiment of the present invention may include: moving the sleeve SB of the synchronizer S to disengage the sleeve SB from the first clutch gear C1 directly connected to the first speed gear P1 and engaged with the second clutch gear C2 directly connected to the second speed gear P2 (S10); synchronizing (e.g., adjusting the speeds to correspond to each other) the speed of the second clutch gear C2 with the speed of the sleeve SB with the motor M connected with the input shaft IN (S20) while the synchronizer ring slides on the friction cone of the second clutch gear C2 by the moving of a sleeve (S10); and completing engagement of the sleeve SB and the second clutch gear C2 (S30), together with the synchronization of the speeds of the second clutch gear C2 and the sleeve SB by the synchronizing (S20).

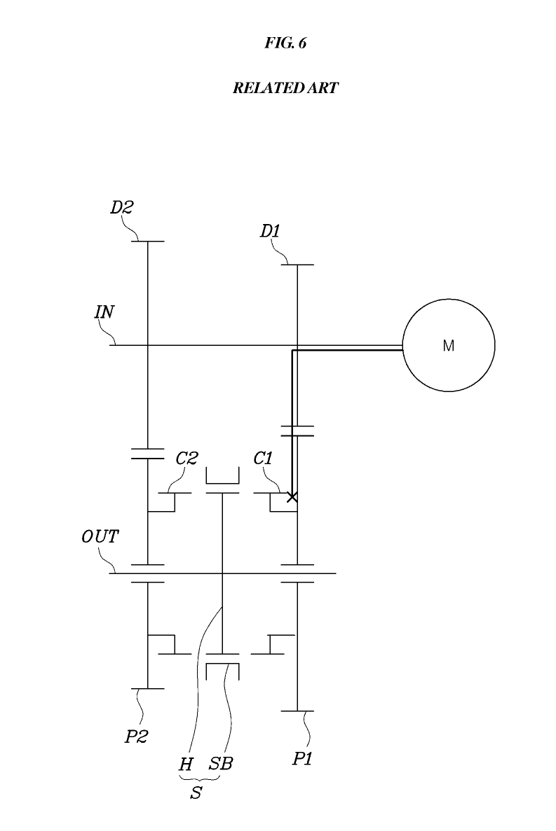

The moving of a sleeve (S10) may include moving the sleeve SB of the synchronizer S to be disengaged from the first clutch gear C1 until the synchronizer ring is pushed to the friction cone of the second clutch gear C2. In other words, for shifting in the related art, a sleeve SB is disengaged from the clutch gear of a current speed gear and stopped at the neutral position as shown in FIG. 6, the speed of the clutch gear of a next speed gear and the speed of the sleeve SB are synchronized by a motor M, and then the sleeve SB is moved to be engaged with the clutch gear of the next speed gear, thereby completing shifting. However, in the present invention, the sleeve SB may be moved to be engaged with a next clutch gear without stopping at a neutral position, together with the synchronizing (S20) by the motor M, and then when synchronization is complete, the sleeve SB and the clutch gear may be engaged, thereby completing shifting. Thus, the preset invention avoids the previously necessary step of stopping at a neutral position before engaging with a next clutch gear.

Accordingly, the moving of a sleeve (S10) may be complete when the engagement (S30) is complete with completion of the synchronizing (S20) and an actuator provided for moving the sleeve SB may continue pushing the sleeve SB to a next clutch gear to be engaged during the moving of a sleeve (S10). In other words, the control method that pushes the sleeve SB engaged with the clutch gear of a current speed gear to engage the sleeve SB with the clutch gear of a desired speed gear, without stopping at a neutral position is considerably different from the control method of the related art, and thus, torque interruption may be minimized and reduced during shifting.

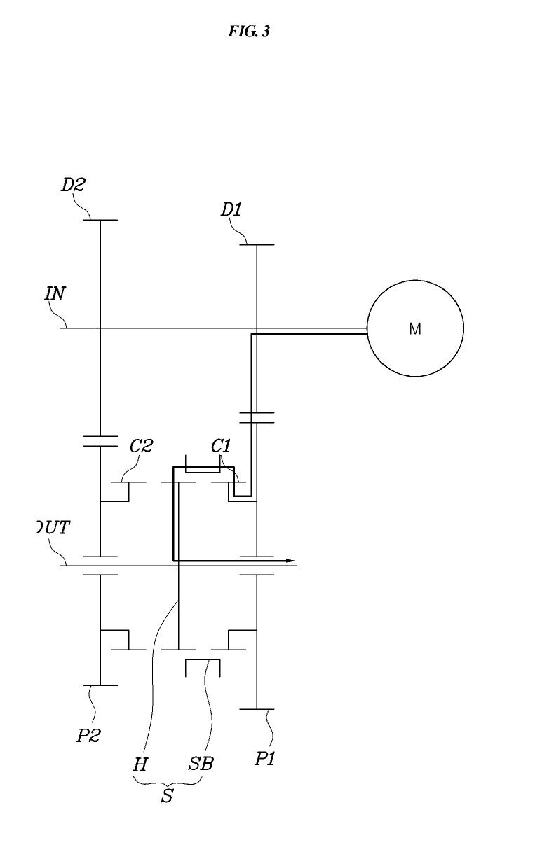

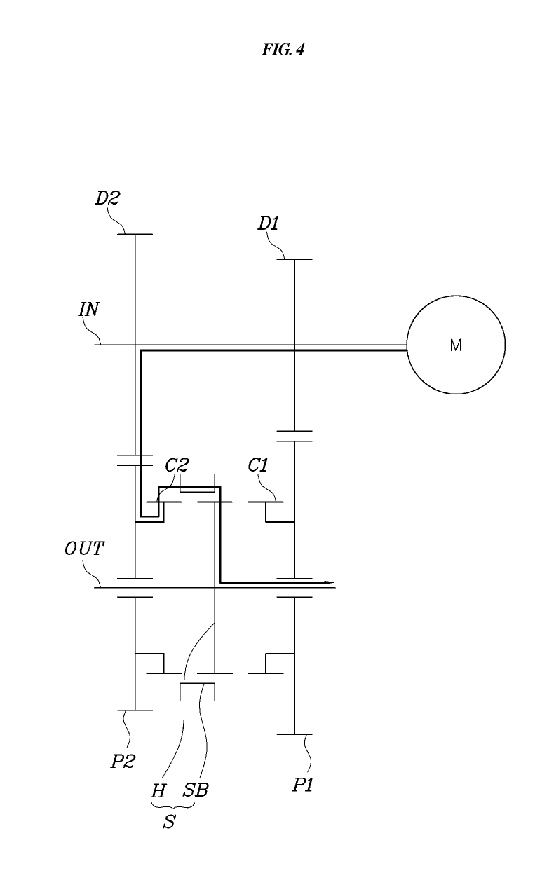

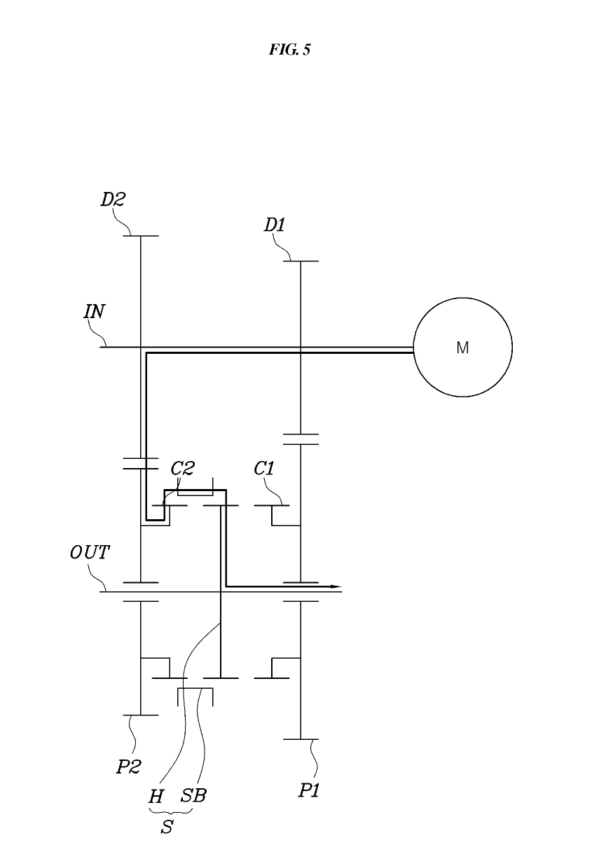

In the related art, in the above-described process, as shown in FIG. 3, of disengaging the sleeve SB engaged with the first clutch gear C1 to the neutral position shown in FIG. 6, of synchronizing the speed of the second clutch gear C2 with the speed of the sleeve SB by adjusting the speed of the input shaft IN with the motor M, and then of moving the sleeve SB again to be engaged with the second clutch C2, about 0.1 seconds is required for the disengagement, about 0.2 seconds are required for the synchronization, and about 0.1 second is required for the engagement, thus, a total of about 0.4 seconds torque interruption may be generated in the related art. However, in the present invention, the sleeve SB may be pushed toward the second clutch C2 simultaneously with disengagement from the first clutch gear C1 to cause torque to be transmitted by friction between the synchronizer ring and the friction cone of the second clutch gear C2, thus reducing the torque interruption to about 0.1 second.

According to the present invention, as described above, torque may be transmitted by friction between the synchronizer ring and the friction cone when the sleeve SB is disengaged from the first clutch gear C1, the speed of the second clutch gear C2 may be synchronized with the speed of the sleeve SB by adjusting the speed of the input shaft IN with the motor M, and when the synchronization is completed, the sleeve SB may be engaged with the second clutch gear C2 by the force applied to the sleeve SB by the moving of a sleeve (S10), such that the movement of the sleeve SB is stopped and the moving of a sleeve (S10) is finished, which means that engagement of the sleeve SB is finished and shifting is completed.

The present invention described above may be explained as follows. The method of the present invention may include: disengaging the sleeve SB of the synchronizer S from the first clutch gear C1 to engage the sleeve SB with the second clutch gear C2; synchronizing the speed of the second clutch gear C2 with the speed of the sleeve SB; and completing engagement of the sleeve SB with the second clutch gear C2 together with the synchronization in the second step. In other words, it may be considered that the disengaging of the sleeve SB corresponds to the moving of a sleeve (S10), the synchronizing of the speed of the second clutch gear C2 corresponds to the synchronizing (S20), and the completing the engagement of the sleeve SB with the second clutch gear C2 corresponds to the completing of engagement (S30). Obviously, the sleeve SB may be moved toward the second clutch gear C2 without stopping immediately upon disengaging from the first clutch gear C1. Further, the synchronization process may be performed during the disengagement process, the completion process may be performed with completion of the synchronization process, and the disengagement process may be completed with completion of the completion process.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of controlling a transmission by an electric controller, which includes a first speed gear and a second speed gear for implementing shifting for two different speeds at both sides from a synchronizer, the method comprising:
moving, by the controller, a sleeve of the synchronizer to disengage the sleeve from a first clutch gear directly connected to the first speed gear and engage the sleeve with a second clutch gear directly connected to the second speed gear;
synchronizing, by the controller, a speed of the second clutch gear with a speed of the sleeve with a motor connected to an input shaft while a synchronizer ring slides on a friction cone of the second clutch gear by the movement of the sleeve; and
completing engagement, by the controller, of the sleeve with the second clutch gear, together with the synchronization of the speeds of the second clutch gear and the sleeve by the synchronizing.

2. The method of claim 1, wherein the moving of the sleeve includes continuing to move the sleeve of the synchronizer to be disengaged from the first clutch gear until the synchronizer ring is pushed to the friction cone of the second clutch gear.

3. The method of claim 1, wherein the moving of the sleeve is completed when the completing of engagement is performed with completion of the synchronizing.

4. The method of claim 1, wherein a first driving gear engaged with the first speed gear and a second driving gear engaged with the second speed gear are fitted on the input shaft connected to the motor, and the first speed gear, the second speed gear, and the synchronizer are mounted on an output shaft.

5. A method of controlling a transmission, comprising:
disengaging, by a controller, a sleeve of a synchronizer from a first clutch gear to engage the sleeve with the second clutch gear;
synchronizing, by the controller, a speed of the second clutch gear with a speed of the sleeve; and
completing engagement, by the controller, of the sleeve with the second clutch gear together with the synchronization.

6. The method of claim 5, wherein in the disengagement process, the sleeve is moved toward the second clutch gear without stopping upon disengaging from the first clutch gear.

7. The method of claim 6, wherein the synchronization process is performed during the disengagement process, the completion process is performed with completion of the synchronization, and the disengagement process is completed with completion of the completion process.

8. A system of controlling a transmission which includes a first speed gear and a second speed gear for implementing shifting for two different speeds at both sides from a synchronizer, the system comprising:
a memory configured to store program instructions; and
a processor configured to execute the program instructions, the program instructions when executed configured to:
move a sleeve of the synchronizer to disengage the sleeve from a first clutch gear directly connected to the first speed gear and engage the sleeve with a second clutch gear directly connected to the second speed gear;
synchronize a speed of the second clutch gear with a speed of the sleeve with a motor connected to an input shaft while a synchronizer ring slides on a friction cone of the second clutch gear by the movement of the sleeve; and
complete engagement of the sleeve with the second clutch gear, together with the synchronization of the speeds of the second clutch gear and the sleeve by the synchronizing.

9. The system of claim 8, wherein the moving of the sleeve includes continuing to move the sleeve of the synchronizer to be disengaged from the first clutch gear until the synchronizer ring is pushed to the friction cone of the second clutch gear.

10. The system of claim 8, wherein the moving of the sleeve is completed when the completing of engagement is performed with completion of the synchronizing.

11. The system of claim 8, wherein a first driving gear engaged with the first speed gear and a second driving gear engaged with the second speed gear are fitted on the input shaft connected to the motor, and the first speed gear, the second speed gear, and the synchronizer are mounted on an output shaft.
